(19) United States
(12) Patent Application Publication
(10) Pub. No.: US 2025/0390121 A1
(43) Pub. Date: Dec. 25, 2025

(54) FLOW RATE RATIO CONTROL DEVICE

(71) Applicant: HORIBA STEC, Co., Ltd., Kyoto-shi (JP)

(72) Inventors: Tomohiro YOSHIDA, Kyoto-shi (JP); Yoshito KOMADA, Kyoto-shi (JP)

(21) Appl. No.: 19/246,043

(22) Filed: Jun. 23, 2025

(30) Foreign Application Priority Data
Jun. 25, 2024 (JP) 2024-101678

(51) Int. Cl. G05D 11/13

(52) U.S. Cl. CPC G05D 11/132

(57) ABSTRACT

The present invention provides a structure in which a control board is easily arranged in a flow rate ratio control device, and includes a plurality of fluid control devices 2 in each of which a fluid sensor 22 and a fluid control valve 23 are provided on a flow path block 21, and a control board 4 that controls the plurality of fluid control devices 2. The control board 4 stands upright with respect to upper surfaces of the flow path blocks 21 along an arrangement direction of the plurality of fluid control devices 2.

### CROSS-REFERENCE TO RELATED APPLICATION(S)

The present application claims priority from Japanese Patent Application No. 2024-101678 filed Jun. 25, 2024, which is incorporated herein by reference in its entirety.

### BACKGROUND OF THE INVENTION

### Technical Field

The present invention relates to a flow rate ratio control device.

### Description of the Related Art

Conventionally, as disclosed in JP 2016-85226 A, there has been considered a flow rate measurement system in which a plurality of mass flow controllers are arranged in parallel in the thickness direction, and a control device is arranged above a casing of the plurality of mass flow controllers.

However, this system has a configuration in which the control device is arranged above the casing of the plurality of mass flow controllers, which enlarges the entire system, and the system cannot be used depending on the installation space.

### PRIOR ART DOCUMENT

### Patent Document

Patent Document 1: JP 2016-85226 A

### SUMMARY OF THE INVENTION

Here, it is conceivable to downsize the system by housing the plurality of mass flow controllers and the control device in one casing.

However, since the plurality of mass flow controllers are arranged in parallel, it is difficult to arrange the control board inside the casing that accommodates the mass flow controllers.

Therefore, the present invention has been made to solve the above-described problem, and a main object thereof is to provide a structure in which a control board is easily arranged in a flow rate ratio control device.

That is, a flow rate ratio control device according to the present invention includes: a plurality of fluid control devices in each of which a fluid sensor and a fluid control valve are mounted on a flow path block; and a control board that controls the plurality of fluid control devices, in which the control board stands upright with respect to upper surfaces of the flow path blocks along an arrangement direction of the plurality of fluid control devices.

According to such a flow rate ratio control device, since the control board stands upright with respect to the upper surfaces of the flow path blocks along the arrangement direction of the plurality of fluid control devices, it is possible to obtain a structure in which the control board can be easily arranged, and for example, the control board can be easily arranged without interfering with the fluid control valves or the fluid sensors. In addition, the control board can be extended in the arrangement direction of the fluid control devices, and it is possible to reduce the height dimension of the control board.

Since the fluid control valves each have a larger height dimension than the fluid sensors, a surplus space is formed above the fluid sensors. In order to effectively utilize the surplus space formed above the fluid sensors and to prevent the flow rate ratio control device from being enlarged, the control board is desirably arranged above the fluid sensors. In addition, a configuration in which the control board is not arranged above the fluid control valves makes it possible to prevent the control board from being an obstacle when the structures of the valves are changed. Note that, as a change in the structures of the valves, for example, it is conceivable to arrange a position sensor that detects the position of a valve body or to change from a piezo valve using a piezo actuator to a solenoid valve using a solenoid.

As a specific embodiment for obtaining a structure in which the control board is easily arranged, it is desirable that the flow rate ratio control device further includes: a base plate on which the plurality of fluid control devices are fixed side by side at an interval; and a support portion provided between fluid control devices adjacent to each other, and the control board is fixed to the support portion.

The support portion is desirably fixed to the base plate between the fluid control devices adjacent to each other.

With this configuration, it is possible to facilitate assembly of the support portion. In addition, machining for assembling the support portion to peripheral components such as the flow path blocks is unnecessary, and it is possible to reduce the machining cost.

As a specific embodiment of the support portion, the support portion desirably includes: a plate fixing portion fixed to the base plate; and a board fixing portion provided upright from the plate fixing portion and to which the control board is fixed.

The flow rate ratio control device of the present invention may include two control boards. In this case, the two control boards are desirably fixed so as to sandwich the support portion.

With this configuration, the two control boards can be fixed to the common support portion, and it is possible to simplify the configuration for fixing the two control boards.

A connector for external communication is desirably provided between the two control boards.

With this configuration, it is possible to provide the connector for external communication with the dead space formed between the two control boards effectively utilized.

The flow rate ratio control device of the present invention desirably further includes a casing that is fixed to the flow path blocks and accommodates the fluid sensor and the fluid control valve of each of the plurality of fluid control devices, the support portion, and the control board. Here, the casing is desirably fixed to the flow path blocks of the fluid control devices located at both ends of the plurality of fluid control devices.

In order to configure a flow rate ratio control device by the flow rate ratio control device of the present invention, it is desirable that the flow rate ratio control device includes an inlet joint that is connected to the flow path block of each of the plurality of fluid control devices and distributes fluid flowing in from one inflow port to the flow path block of each of the plurality of fluid control devices, and the control board controls the plurality of fluid control devices to control the ratio of the flow rates flowing out from the plurality of fluid control devices.

According to the present invention configured as described above, it is possible to provide a structure in which a control board is easily arranged in a flow rate ratio control device.

### BRIEF DESCRIPTION OF THE DRAWINGS

FIG. 1 is a perspective view of a flow rate ratio control device according to an embodiment of the present invention;

FIG. 2 is a perspective view of the flow rate ratio control device according to the embodiment with a casing removed;

FIG. 3 is a front view of the flow rate ratio control device according to the embodiment;

FIG. 4 is a plan view of the flow rate ratio control device according to the embodiment;

FIG. 5 is a side view of the flow rate ratio control device according to the embodiment; and

FIG. 6 is an exploded perspective view of the flow rate ratio control device according to the embodiment.

### DETAILED DESCRIPTION

Hereinafter, an embodiment of a flow rate ratio control device according to the present invention will be described with reference to the drawings.

Note that, for easy understanding, each of the drawings shown below is schematically drawn with appropriate omission or exaggeration. The same components are denoted by the same reference numerals, and the description thereof will be omitted as appropriate.

### <Device Configuration>

A flow rate ratio control device 100 of the present embodiment is used, for example, in a semiconductor manufacturing process, and is used to introduce gas for a semiconductor process into a vacuum chamber accommodating wafers from each of a plurality of inlet ports of the vacuum chamber at a predetermined flow rate ratio.

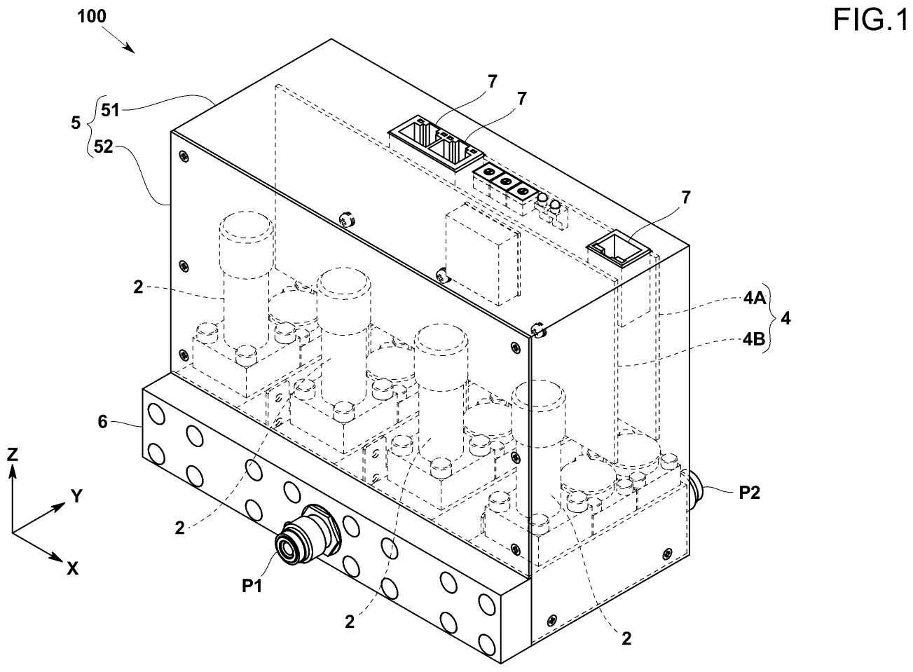

Specifically, as illustrated in FIGS. 1 to 6, the flow rate ratio control device 100 includes a plurality of (here, four) fluid control devices 2, a base plate 3 on which the plurality of fluid control devices 2 are fixed, a control board 4 that controls the plurality of fluid control devices 2, and a casing 5 that accommodates the plurality of fluid control devices 2 and the control board 4.

Each of the fluid control devices 2 includes a rectangular parallelepiped flow path block 21 in which an internal flow path 21R is formed, fluid sensors 22 that are mounted on one surface (upper surface) of the flow path block 21 and measure the flow rate of a fluid flowing through the internal flow path 21R, and a fluid control valve 23 that controls the flow rate of the fluid flowing through the internal flow path 21R.

The fluid sensors 22 of the present embodiment include an upstream pressure sensor 22a that measures pressure on the upstream side of a fluid resistance element (not illustrated) provided in the internal flow path 21R, and a downstream pressure sensor 22b that measures pressure on the downstream side of the fluid resistance element. A detection signal from each of the pressure sensors 22a and 22b is transmitted to the control board 4 described later.

In addition, the fluid control valve 23 is a so-called piezo valve, and moves a valve body forward and backward with respect to a valve seat by applying a drive voltage to a piezo actuator, thereby adjusting the valve opening degree. The drive voltage applied to the fluid control valve 23 is input from the control board 4 described later. The fluid control valve 23 of the present embodiment is provided on the upstream side of the pressure sensors 22a and 22b, which are the fluid sensors 22.

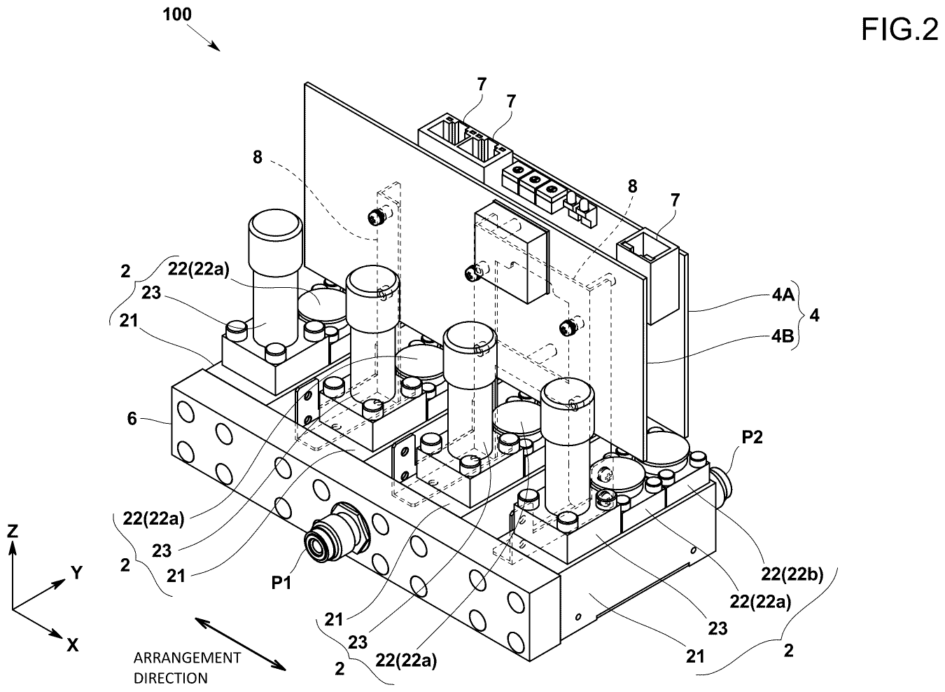

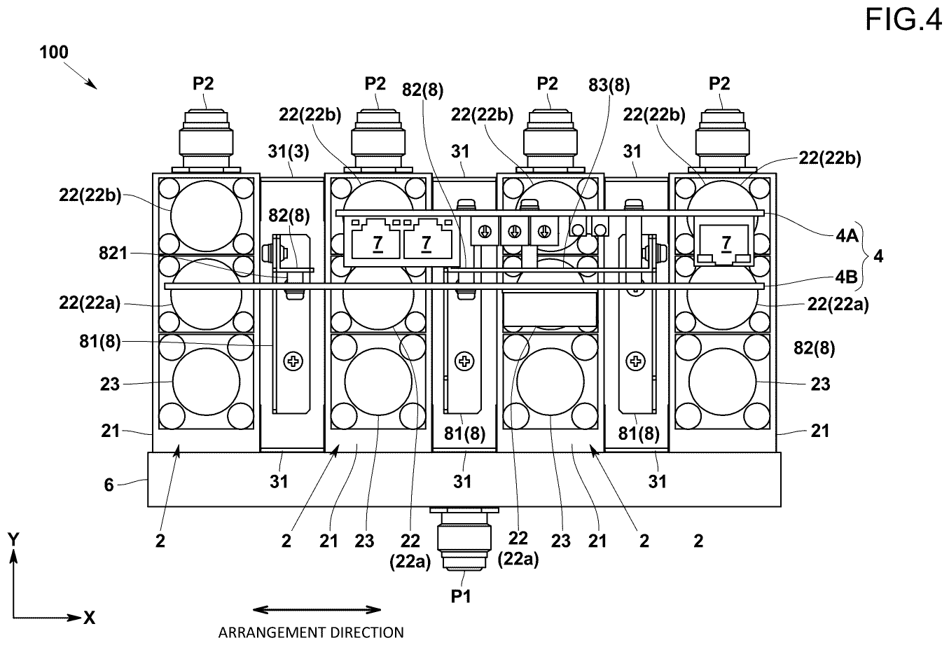

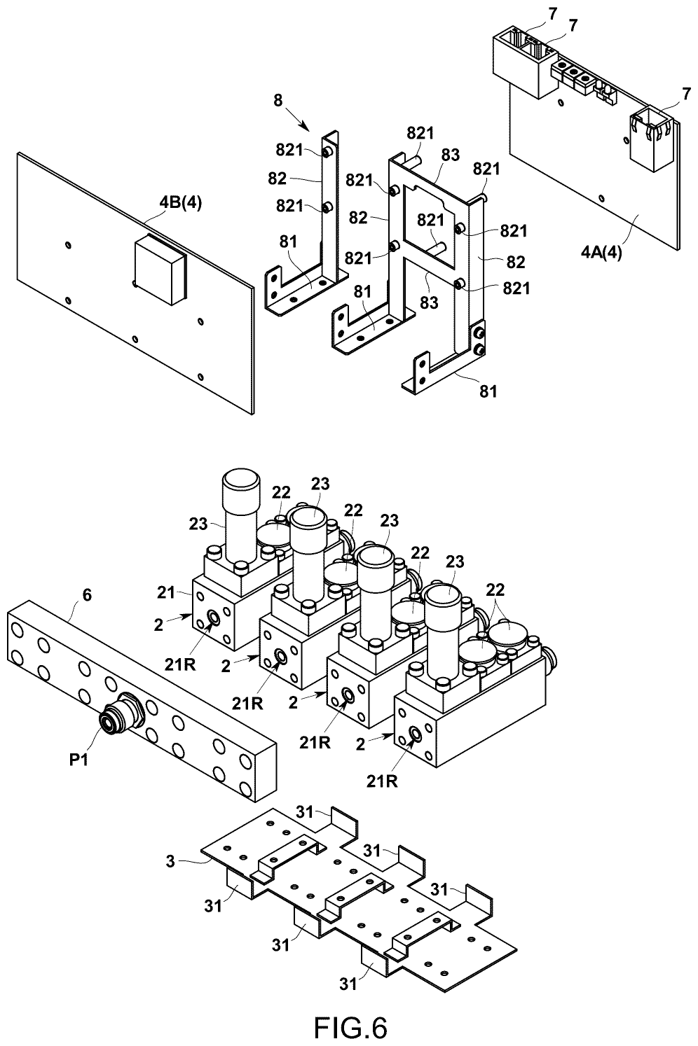

As illustrated in FIGS. 2 to 4 and 6, the base plate 3 is a part on which the plurality of fluid control devices 2 are fixed side by side at intervals. Specifically, on the base plate 3, the flow path blocks 21 of the plurality of fluid control devices 2 are fixed side by side at equal intervals. Here, as illustrated in FIGS. 4 and 6, the base plate 3 has spacer portions 31 for making the intervals between the flow path blocks 21 constant. Furthermore, bottom surfaces of the flow path blocks 21 are fixed to an upper surface of the base plate 3. Note that, in a state where the plurality of fluid control devices 2 are fixed to the base plate 3, the arrangement order of the fluid sensors 22 and the fluid control valve 23 is the same in the flow path blocks 21 of the plurality of fluid control devices 2 (see FIGS. 2 and 4 and the like).

In addition, an inlet joint 6 is connected to one end face (front surface) of each of the plurality of flow path blocks 21 fixed to the base plate 3. Note that the internal flow paths 21R are opened on the front surfaces of the flow path blocks 21 (see FIG. 6). The inlet joint 6 distributes fluid flowing in from one inflow port P1 to the internal flow path 21R of the flow path block 21 of each of the plurality of fluid control devices 2. The other end face (rear surface) of each of the plurality of flow path blocks 21 is provided with an outflow port P2 to which a pipe connected to an introduction port of the vacuum chamber is connected.

The control board 4 of the present embodiment includes a first control board 4A and a second control board 4B. The first control board 4A performs arithmetic processing such as flow distribution control based on a target flow rate ratio input from the outside and processing of various data. The second control board 4B acquires a detection signal from each of the fluid sensors 22 and controls each of the fluid control valves 23.

In addition, the control board 4 performs control such that the flow rate ratio of the gas flowing through the internal flow paths 21R of the plurality of fluid control devices 2 is the target flow rate ratio. Specifically, the control board 4 is configured to sequentially acquire information on the flow rate from each of the fluid control devices 2. More specifically, the control board 4 calculates the target flow rate for each of the internal flow paths 21R on the basis of the sum of the measured flow rates of the gas flowing through the internal flow paths 21R, which are measured by the fluid sensors 22 of the fluid control devices 2, and the target flow rate ratio. Here, the sum of the measured flow rates of the gas flowing through the internal flow paths 21R is also the flow rate of the gas flowing in from the inflow port P1. On the basis of the deviation between the target flow rates each individually set for one of the fluid control devices 2 and the measured flow rates of the gas flowing through the internal flow paths 21R measured by the fluid sensors 22, the control board 4 then performs flow rate feedback control so as to reduce the deviation.

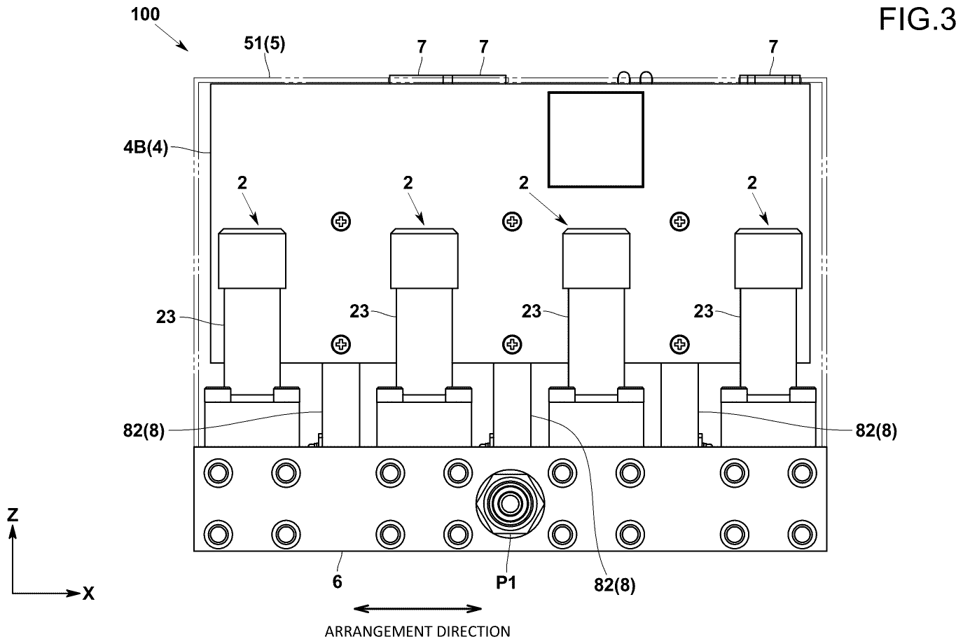

The first control board 4A is provided with a connector 7 for external communication such as EtherCAT or Ethernet, and is connected to the second control board 4B via a signal cable. In addition, a signal cable of each of the fluid sensors 22 (the upstream pressure sensor 22a and the downstream pressure sensor 22b) and a signal cable of each of the fluid control valves 23 are connected to the second control board 4B. Note that the first control board 4A and the second control board 4B each have a rectangular shape (see FIGS. 3 and 6).

As illustrated in FIGS. 1, 3, and 5, the casing 5 has a substantially rectangular parallelepiped box shape that accommodates the plurality of fluid control devices 2 and the control board 4. The casing 5 of the present embodiment is fixed to the flow path blocks 21 of the fluid control devices 2 located at both ends of the plurality of fluid control devices 2.

Specifically, the casing 5 includes a first case element 51 forming left and right side surfaces, an upper surface, and a rear surface, and a second case element 52 forming a front surface. A configuration is adopted in which the first case element 51 is fixed to the flow path blocks 21, and the second case element 52 is connected to the first case element 51.

Thus, as illustrated in FIGS. 2 to 6, the flow rate ratio control device 100 of the present embodiment includes a support portion 8 to which the control board 4 is fixed inside the casing 5.

The support portion 8 is arranged between the fluid control devices 2 adjacent to each other. In the present embodiment, as particularly illustrated in FIG. 4, the support portion 8 is fixed to the upper surface of the base plate 3 between the flow path blocks 21 of the fluid control devices 2 adjacent to each other.

Specifically, as illustrated in FIGS. 3 to 6, the support portion 8 includes one or more plate fixing portions 81 fixed to the upper surface of the base plate 3, and one or more board fixing portions 82 provided upright from the plate fixing portions 81 and to which the control board 4 is fixed.

The one or more plate fixing portions 81 each have a width that fits between the flow path blocks 21 adjacent to each other, and are fixed, in the present embodiment, to the upper surface of the base plate 3 at a plurality of positions (two positions). Here, by adopting a structure in which the plate fixing portions 81 are fixed to the upper surface of the base plate 3, the work of fixing the plate fixing portions 81 is simplified. In addition, the plurality of board fixing portions 82 are provided extending substantially perpendicularly to the flow path blocks 21, and are provided, in the present embodiment, on a straight line along the arrangement direction (X direction) of the plurality of fluid control devices 2. The board fixing portions 82 are each formed with boss portions 821 for screwing the two control boards 4A and 4B. Note that one of the control boards 4A and 4B (for example, the control board 4B) may be fixed to the board fixing portions 82, and the other of the control boards 4A and 4B (for example, the control board 4A) may be fixed to the one of the control boards 4A and 4B fixed to the board fixing portions 82 via spacers or the like.

The present embodiment adopts a configuration in which the plate fixing portions 81 are each fixed to one of three intervals formed between the four fluid control devices 2, and the board fixing portions 82 are provided at the three intervals. In addition, a configuration is adopted in which two board fixing portions 82 are connected by a crossbar 83. Note that the number of the plate fixing portions 81 and the number of the board fixing portions 82 are not limited to these, and the board fixing portions 82 do not have to be connected by the crossbar 83.

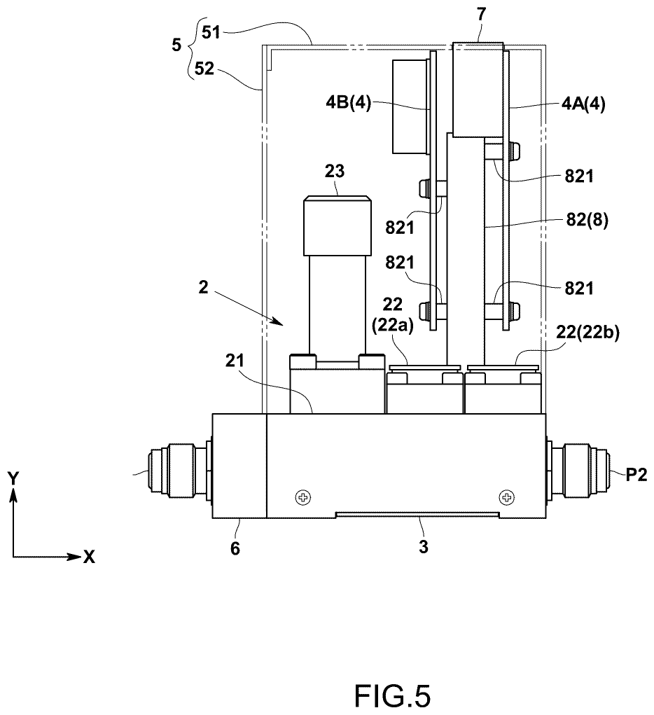

The board fixing portions 82 extend upward from the sides of the fluid sensors 22 in the flow path blocks 21 adjacent to each other. By the two control boards 4A and 4B being fixed to the support portion 8, the two control boards 4A and 4B are arranged above the fluid sensors 22 (see FIGS. 4 and 5).

In addition, the two control boards 4A and 4B are arranged so as to cross the flow path blocks 21 of the plurality of fluid control devices 2 (see FIGS. 1 to 4). In the present embodiment, the longitudinal direction of the two control boards 4A and 4B is arranged along the arrangement direction (X direction) of the plurality of fluid control devices 2. Here, the arrangement direction is a direction perpendicular to the longitudinal direction of the flow path blocks 21 of the fluid control devices 2. In addition, the arrangement direction of the present embodiment is a direction perpendicular to the direction from the inlets to the outlets of the flow path blocks 21 of the fluid control devices 2.

Furthermore, the two control boards 4A and 4B stand upright with respect to the upper surfaces of the flow path blocks 21 (see FIGS. 1 to 4). Specifically, the two control boards 4A and 4B are fixed to the board fixing portions 82 of the support portion 8 so as to sandwich the board fixing portions 82, thereby being fixed in the vertical direction and standing upright with respect to the upper surfaces of the flow path blocks 21. That is, the two control boards 4A and 4B are arranged such that the out-of-plane direction (direction perpendicular to the board plane) of the two control boards 4A and 4B faces laterally. At this time, the first control board 4A is fixed to the board fixing portions 82 such that the connector 7 provided on the first control board 4A is positioned between the two control boards 4A and 4B.

### Effects of Present Embodiment

According to the flow rate ratio control device 100 of the present embodiment configured as described above, since the control boards 4A and 4B are arranged so as to stand upright with respect to the upper surfaces of the flow path blocks 21 along the arrangement direction of the plurality of fluid control devices 2, it is possible to obtain a structure in which the control boards 4A and 4B can be easily arranged, and for example, the control boards 4A and 4B can be easily arranged without interfering with the fluid control valves 23 or the fluid sensors 22. In addition, the control boards 4A and 4B can be extended in the arrangement direction of the fluid control devices 2, and it is possible to reduce the height dimensions of the control boards.

In addition, since the support portion 8 is arranged between the fluid control devices 2 adjacent to each other and the control boards 4A and 4B are fixed to the support portion 8, it is possible to obtain a structure in which the control boards 4A and 4B can be easily arranged. Here, since the support portion 8 is fixed to the base plate 3 between the fluid control devices 2 adjacent to each other, it is possible to facilitate assembly of the support portion 8. In addition, machining for assembling the support portion 8 to peripheral components such as the flow path blocks 21 is unnecessary, and it is possible to reduce the machining cost.

Since the two control boards 4A and 4B are arranged above the fluid sensors 22, the surplus space formed above the fluid sensors 22 is effectively used, and it is possible to prevent the flow rate ratio control device 100 from being enlarged. In addition, a configuration in which the two control boards 4A and 4B are not arranged above the fluid control valves 23 makes it possible to prevent the two control boards 4A and 4B from being obstacles when the structures of the fluid control valves 23 are changed. Note that, as a change in the structures of the fluid control valves 23, it is conceivable to mount a position sensor that detects the position of a valve body, to mount a mechanism that enlarges the displacement of a valve body, or to change from a piezo valve to a solenoid valve.

### OTHER EMBODIMENTS

For example, the above embodiment adopts a configuration in which the support portion 8 is fixed to the base plate 3, but a configuration may be adopted in which the support portion 8 is fixed to another member such as the flow path blocks or the casing. Even in this case, the support portion 8 is desirably arranged between the fluid control devices 2 adjacent to each other.

In addition, in the above embodiment, the two control boards 4A and 4B are both arranged so as to stand upright with respect to the flow path blocks 21, but at least one of the control boards 4A and 4B may be arranged so as to lie on the flow path blocks 21. That is, the two control boards 4A and 4B may be arranged such that the out-of-plane direction of the two control boards 4A and 4B faces the vertical direction (Z direction). In particular, in the flow rate ratio control device 100, the connector 7 for external communication is often arranged on an upper part of the device, and a configuration may be adopted in which, with the control board 4A standing upright, the other control board 4B is arranged so as to lie on the flow path blocks 21.

Furthermore, the above embodiment adopts a configuration in which the two control boards 4A and 4B are provided, but a configuration may be adopted in which one control board 4 is provided, or three or more control boards 4 are provided.

In addition, the above embodiment adopts a configuration in which the four fluid control devices 2 are arranged at intervals, but in addition, a configuration may be adopted in which two or more fluid control devices 2 may be arranged at an interval.

In addition, various modifications and combinations of embodiments may be made without departing from the gist of the present invention.

### REFERENCE CHARACTER LIST

100 flow rate ratio control device
2 fluid control device
21 flow path block
22 fluid sensor
23 fluid control valve
3 base plate
4 control board
5 casing
6 inlet joint
P1 inflow port
7 connector for external communication
8 support portion
81 plate fixing portion
82 board fixing portion

1. A flow rate ratio control device comprising:
a plurality of fluid control devices in each of which a fluid sensor and a fluid control valve are mounted on a flow path block; and
a control board that controls the plurality of fluid control devices,
wherein the control board stands upright with respect to upper surfaces of the flow path blocks along an arrangement direction of the plurality of fluid control devices.

2. The flow rate ratio control device according to claim 1, wherein the control board is arranged above the fluid sensors.

3. The flow rate ratio control device according to claim 1, further comprising:
a base plate on which the plurality of fluid control devices are fixed side by side at an interval; and
a support portion provided between fluid control devices adjacent to each other,
wherein the control board is fixed to the support portion.

4. The flow rate ratio control device according to claim 3, wherein the support portion is fixed to the base plate between the fluid control devices adjacent to each other.

5. The flow rate ratio control device according to claim 4, wherein
the support portion includes:
a plate fixing portion fixed to the base plate; and
a board fixing portion provided upright from the plate fixing portion and to which the control board is fixed.

6. The flow rate ratio control device according to claim 3, comprising two control boards,
wherein the two control boards are fixed so as to sandwich the support portion.

7. The flow rate ratio control device according to claim 6, wherein a connector for external communication is provided between the two control boards.

8. The flow rate ratio control device according to claim 1, further comprising a casing that is fixed to the flow path blocks and accommodates the fluid sensor and the fluid control valve of each of the plurality of fluid control devices and the control board.

9. The flow rate ratio control device according to claim 1, further comprising an inlet joint that is connected to the flow path block of each of the plurality of fluid control devices and distributes fluid flowing in from one inflow port to the flow path block of each of the plurality of fluid control devices.
